(19) United States
(12) Patent Application Publication
(10) Pub. No.: US 2024/0310180 A1
(43) Pub. Date: Sep. 19, 2024

(54) VEHICLE SUBSTITUTE SIMULATION DEVICE AND VEHICLE SUBSTITUTE SIMULATION METHOD

(71) Applicant: HONDA MOTOR CO., LTD., Tokyo (JP)

(72) Inventors: Naohiro AKUZAWA, Tokyo (JP); Kei HIROHATA, Tokyo (JP); Adil GUPTA, Tokyo (JP); Yohei UMEMOTO, Tokyo (JP); Daisuke IDE, Tokyo (JP)

(21) Appl. No.: 18/595,442

(22) Filed: Mar. 5, 2024

(30) Foreign Application Priority Data
Mar. 16, 2023 (JP) 2023-042102

(51) Int. Cl. G01C 21/34; B60L 58/13; G01C 21/36

(52) U.S. Cl. CPC G01C 21/3469; B60L 58/13; G01C 21/3423; G01C 21/3682; B60L 2240/622; B60L 2260/52

(57) ABSTRACT

A vehicle substitute simulation device, including a position information acquisition unit for acquiring movement information from an information terminal of a user, an electric vehicle information storage unit for storing electric vehicle performance information relating to a travel performance of an electric vehicle, a ride information acquisition unit for acquiring, from the movement information acquired in a predetermined period, ride information that includes at least movement distance information and waypoint information on an internal combustion engine vehicle driven by the user and including an internal combustion engine, a SoC calculation unit for calculating, from the electric vehicle performance information and the ride information, a remaining amount of electric power of the electric vehicle as SoC information for each waypoint for a case in which the user switches to the electric vehicle, and an output unit for outputting the SoC information to the information terminal of the user.

This application is based on and claims the benefit of priority from Japanese Patent Application No. 2023-042102, filed on 16 Mar. 2023, the content of which is incorporated herein by reference.

### BACKGROUND OF THE INVENTION

### Field of the Invention

The present disclosure relates to a vehicle substitute simulation device and a vehicle substitute simulation method that acquire, from a transition of position information on an information terminal of a user, ride information that includes movement distance information and waypoint information on an internal combustion engine vehicle that the user drives, and, based on the ride information, estimate charging information for each waypoint for a case in which the user switches from the internal combustion engine vehicle that is currently owned by the user to an electric vehicle.

### Related Art

Various efforts have been made to make carbon neutrality a reality to achieve a sustainable society. For this reason, electric vehicles (EVs) are now being sold by automobile manufacturers or the like so as to realize a sustainable society by not discharging gases such as carbon dioxide during travel, and selection of electric vehicles has become an option for users to consider in a case of next purchasing a vehicle. On the other hand, it has been pointed out that the distance that an electric vehicle can travel on one charge (travel distance per charge) is generally shorter than the distance that an internal combustion engine vehicle (for example, a gasoline-powered car) can travel on a full tank of gasoline. Moreover, it has been also pointed out that a time necessary for one charge of an electric vehicle is generally longer than a time necessary for filling a gasoline tank of an internal combustion engine vehicle (for example, a gasoline-powered automobile). For these reasons, for a case in which the user switches from an internal combustion engine vehicle that is currently owned by the user to an electric vehicle and adopts a travel mode that is the same as a travel mode of the internal combustion engine vehicle that is currently owned by the user, it is difficult for the user to grasp the number of charges, the charging time, and the like at a charging facility away from home that would be necessary, and thus concerns of the user have not yet been alleviated in a case of considering a replacement purchase.

In this respect, Patent Document 1 discloses a technology for accurately calculating a necessary power consumption of a battery for an electric vehicle to travel on a road link. Specifically, Patent Document 1 discloses a technology for accurately calculating a necessary power consumption of a battery for an electric vehicle to travel on a predetermined road segment in accordance with an estimated number of stops in the road segment. Non-Patent Document 1 also discloses a technology of a vulnerable person protection system that uses acceleration data, together with position information that is determined by a smartphone or the like, to determine a behavior of a user of a smartphone or the like. In this technology, the behavior of the user is determined to be riding in a vehicle, riding on a train, walking, or the like.

However, in the technology described in Patent Document 1, for a case in which the user switches from an internal combustion engine vehicle that is currently owned by the user to an electric vehicle and adopts a travel mode that is the same as a travel mode of an internal combustion engine vehicle that is currently owned by the user, it is especially difficult for the user to grasp how much power of a battery is consumed from one day's use of the vehicle. For this reason, to grasp the power consumption of a battery and the like, it is necessary for the user themself to analyze the travel mode of the internal combustion engine vehicle and calculate an estimated power consumption, which is practically difficult for the user. For this reason, the concerns of the user have not yet been alleviated in a case of considering a replacement purchase.
Patent Document 1: Japanese Patent No. 6236887
Non-Patent Document 1: “Proposal of a System, TLIFS, of Protecting Vulnerable People Using a Smartphone”, The 74th National Convention of IPSJ, Vol. 1, pp. 353-354, 2012.

### SUMMARY OF THE INVENTION

For a case in which the user switches from an internal combustion engine vehicle that is currently owned by the user to an electric vehicle and adopts a travel mode that is the same as a travel mode of the current internal combustion engine vehicle, it is desirable that charging information that includes a power consumption of a battery and the like can be estimated from one day's use of the vehicle by the user, and that concerns of the user can be alleviated in a case of considering a replacement purchase.

The present disclosure has been made in view of the above circumstances. An object of the present disclosure is to provide a vehicle substitute simulation device and a vehicle substitute simulation method that acquire, from a transition of the position information on the information terminal of the user, ride information that includes movement distance information, waypoint information, and the like of an internal combustion engine vehicle driven by a user, and, for a case in which the user switches from the internal combustion engine vehicle that is currently owned by the user to the electric vehicle and adopts a travel mode that is the same as a travel mode of the current internal combustion engine vehicle, estimate, based on the acquired ride information, charging information that includes a power consumption of a battery. In this way, the concerns of the user can be alleviated by providing objective information for the user in a case of considering a replacement purchase.
(1) A vehicle substitute simulation device (for example, a vehicle substitute simulation device 1 that is described later) according to an embodiment of the present disclosure including:
a position information acquisition unit (for example, a position information acquisition unit 10 that is described later) configured to acquire movement information that includes a transition-over-time of position information from an information terminal (for example, a mobile terminal 20A that is described later) carried by a user;
an electric vehicle information storage unit (for example, an electric vehicle information storage unit 123 that is described later) configured to store electric vehicle performance information relating to a travel performance of an electric vehicle that includes a motor driven by electricity;
a ride information acquisition unit (for example, a ride information acquisition unit 111 that is described later) configured to acquire, from the movement information acquired in a predetermined period, ride information that includes at least movement distance information and waypoint information on an internal combustion engine vehicle (for example, a vehicle 20 that is described later) driven by the user and including an internal combustion engine;
a State of Charge (SoC) calculation unit (for example, an SoC calculation unit 112 that is described later) configured to calculate, from the electric vehicle performance information and the ride information, a remaining amount of electric power (SoC) of the electric vehicle as SoC information for each waypoint for a case in which the user switches to the electric vehicle; and
an output unit (for example, an output unit 113 that is described later) configured to output, to the information terminal of the user, the SoC information for each waypoint in the waypoint information.

According to aspect (1), it is possible to easily grasp what kind of power consumption is necessary for each waypoint in a case in which the user substitutes an electric vehicle for an internal combustion engine vehicle, which alleviates the concerns of the user.
(2) The vehicle substitute simulation device according to aspect 1 (for example, the vehicle substitute simulation device 1 that is described later),
in a case in which the transition of the position information is at a position within a predetermined range for a predetermined time or longer, the ride information acquisition unit (for example, the ride information acquisition unit 111 that is described later) may determine that the position is one waypoint.

According to aspect (2), it is possible to accurately calculate the waypoints.

(3) The vehicle substitute simulation device according to aspect 1 or 2 (for example, the vehicle substitute simulation device 1 that is described later),
in which the position information acquisition unit (for example, the position information acquisition unit 110 that is described later) further acquires vibration information on the information terminal (for example, the information terminal 20A that is described later), and
the ride information acquisition unit (for example, the ride information acquisition unit 111 that is described later) determines, based on the vibration information, whether or not the internal combustion engine vehicle (for example, the vehicle 20 that is described later) moves and then may acquire the movement distance information.

According to aspect (3), it is possible to easily grasp what kind of power consumption is necessary for each waypoint because the movement by the vehicle is accurately calculated.

(4) The vehicle substitute simulation device according to aspect 1 or 2 (for example, the vehicle substitute simulation device 1 that is described later),
further including a map information storage unit (for example, a map information storage unit 121 that is described later) configured to store map information that includes information on a public transit system, in which
the ride information acquisition unit (for example, the ride information acquisition unit 111 that is described later) determines, based on the map information, whether the transition of the position information is movement by the internal combustion engine vehicle (for example, the vehicle 20 that is described later) engine vehicle or movement by the public transit system and then may acquire the movement distance information.

According to aspect (4), it is possible to easily grasp what kind of power consumption is necessary for each waypoint because the movement by the vehicle is accurately calculated.

(5) The vehicle substitute simulation device according to aspect 1 or 2 (for example, the vehicle substitute simulation device 1 that is described later),
in which the electric vehicle information storage unit (for example, the electric vehicle information storage unit 123 that is described later) further stores the electric vehicle performance information for each vehicle model of a plurality of electric vehicles, and
the SoC calculation unit (for example, the SoC calculation unit 112 that is described later) may calculate the SoC information for each waypoint for each vehicle model of the plurality of electric vehicles.

(6) A vehicle substitute simulation method executed by a computer, including:
a position information acquisition step of acquiring movement information that includes a transition-over-time of position information from an information terminal (for example, the information terminal 20A that is described later) that is carried by a user;
an electric vehicle information storage step of storing electric vehicle performance information relating to a travel performance of an electric vehicle that includes a motor driven by electricity;
a ride information acquisition step of acquiring, from the movement information acquired in a predetermined period, ride information that includes at least movement distance information and waypoint information on an internal combustion engine vehicle (for example, the vehicle 20 that is described later) driven by the user and including an internal combustion engine;
an SoC calculation step of calculating, from the electric vehicle performance information and the ride information, a remaining amount of electric power (SoC) of the electric vehicle as SoC information for each waypoint for a case in which the user switches to the electric vehicle; and
an output step of outputting, to the information terminal of the user, the SoC information for each waypoint in the waypoint information.

According to aspect (6), it is possible to obtain the same effect as that of the vehicle substitute simulation device according to aspect (1).

According to the present disclosure, it is possible to acquire ride information that includes movement distance information, waypoint information, and the like of an internal combustion engine vehicle that is driven by a user from a transition of position information on an information terminal of the user, and estimates, based on the acquired ride information, charging information that includes a power consumption of a battery for a case in which the user switches from an internal combustion engine vehicle that is currently owned by the user to an electric vehicle and adopts a travel mode that is the same as a travel mode of the current internal combustion engine vehicle. In this way, it is possible to provide objective information for the user to consider a replacement purchase.

### BRIEF DESCRIPTION OF THE DRAWINGS

FIG. 1 is a schematic diagram that illustrates a vehicle substitute simulation system according to an embodiment of the present disclosure;

FIG. 2 is a block diagram that illustrates a basic configuration of a vehicle substitute simulation device according to an embodiment of the present disclosure;

FIG. 3 is a diagram that illustrates an example of electric vehicle information according to an embodiment of the present disclosure;

FIG. 4 is a block diagram that illustrates a basic configuration of a mobile terminal according to an embodiment of the present disclosure;

FIG. 5 is a diagram that illustrates an example of a display of a result of a simulation process according to an embodiment of the present disclosure; and

FIG. 6 is a flowchart that illustrates a vehicle substitute simulation process according to an embodiment of the present disclosure.

### DETAILED DESCRIPTION OF THE INVENTION

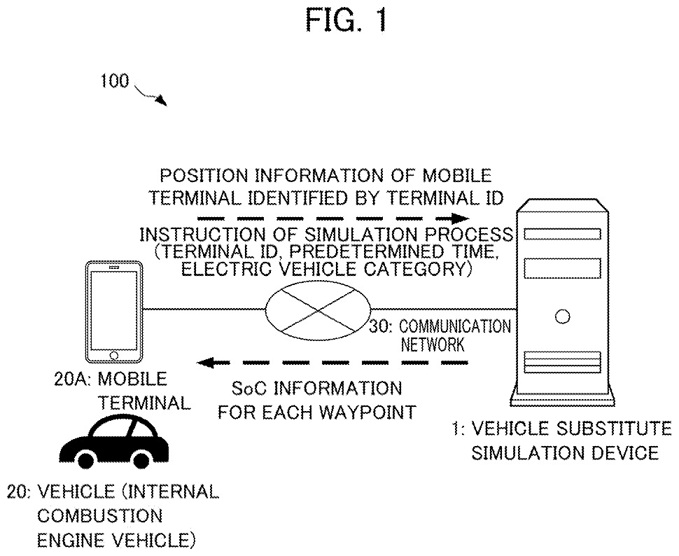

Hereinafter, a preferred embodiment of a vehicle substitute simulation device of the present disclosure will be described with reference to the drawings. FIG. 1 illustrates a basic configuration of a vehicle substitute simulation system 100. The vehicle substitute simulation system 100 includes a vehicle substitute simulation device 1, a mobile terminal 20A, a vehicle 20, and a communication network 30.

The mobile terminal 20A is a PC, a smartphone, a tablet terminal, or the like of a user who owns the vehicle 20. Application software that cooperates with the vehicle 20 of the user may be installed in the mobile terminal 20A.

The mobile terminal 20A acquires speed information and vibration information that is measured by an acceleration sensor, a vibration sensor, or the like that are included in the mobile terminal 20A, receives a Global Positioning System (GPS) satellite signal by a GPS sensor, and acquires position information (latitude and longitude) of the mobile terminal 20A, and time information with which the position information is determined. The mobile terminal 20A transmits the acquired speed information, the vibration information, the position information, the time information, and the like to the vehicle substitute simulation device 1 together with identification information (a terminal ID) of the mobile terminal 20A. The vehicle substitute simulation device 1 stores the received position information on the mobile terminal 20A (i.e., the position information on the vehicle 20) in association with the identification information (the terminal ID) of the mobile terminal 20A.

A simulation process in which the vehicle substitute simulation device 1 receives instructions (input), via the mobile terminal 20A, to perform a simulation of a case in which the user switches from the vehicle 20 (internal combustion engine vehicle) that is owned by the user to the electric vehicle, and the mobile terminal 20A may display output information on results of the simulation process that is output from the vehicle substitute simulation device 1.

The vehicle 20 is an internal combustion engine vehicle (for example, a gasoline-powered automobile). In a case in which the vehicle 20 is a connected car based on, for example, telematics technology, the vehicle 20 can communicate with a connected system (not shown) that is operated by a vehicle manufacturer of the vehicle 20. Thus, the vehicle substitute simulation device 1 may be configured to receive, from the connected system (not shown) via the communication network 30, the position information on the vehicle 20, together with time information, instead of the position information on the mobile terminal 20A. Hereinafter, unless otherwise specified, the vehicle 20 indicates an internal combustion engine vehicle.

The above describes an outline of the system configuration of the present embodiment.

Next, each configuration is described.

### <Vehicle Substitute Simulation Device 1>

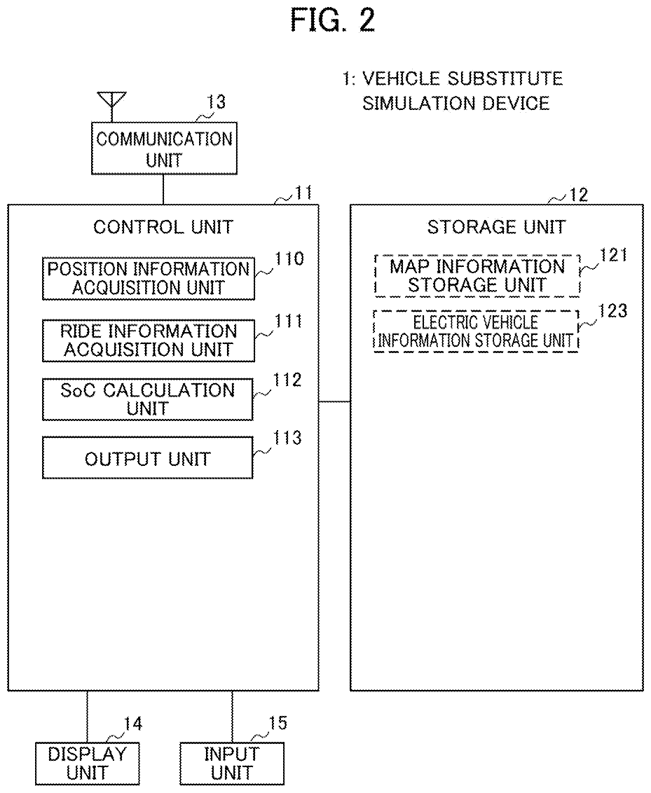

FIG. 2 is a block diagram that illustrates a basic configuration of the vehicle substitute simulation device 1. As illustrated in FIG. 2, the vehicle substitute simulation device 1 includes a control unit 11, a storage unit 12, a communication unit 13, a display unit 14, and an input unit 15.

The control unit 11 is configured with an arithmetic processor such as a microprocessor and controls each unit that configures the vehicle substitute simulation device 1. The control unit 11 is described in detail later.

The storage unit 12 is configured with a semiconductor memory or the like, and stores various kinds of information, such as map information, electric vehicle performance information, and programs such as control programs called firmware and operating systems and programs for carrying out position information acquisition of each mobile terminal 20A, the simulation process, and output process.

As illustrated in FIG. 2, the storage unit 12 includes the map information storage unit 121 and the electric vehicle information storage unit 123. The present embodiment describes an example of a configuration in which the map information includes charging facility information, but the present disclosure is not limited thereto. The charging facility information may be stored in a charging facility information storage unit (not shown) or the like.

The map information storage unit 121 stores facility information that includes road information, facility type information that indicates attributes of each facility for a plurality of facilities, position information that is associated with each facility, and the like. In the present embodiment, the charging facility information is included as facility information. The charging facility information includes, for example, facility type information that indicates a charging facility, a charging facility identification number (charging facility identification ID) that identifies the charging facility, a charging facility name, position information on the charging facility (including road information facing the charging facility), a telephone number, an address, business times, power supply performance information on a charger installed in the charging facility, and the like. Here, the power supply performance information indicates, for example, a charging method (normal charging, rapid charging) and a power output (power supplied per hour; in the case of CHAdeMO standards, rapid charging may include approximately 20 kW to 50 kW, or unique to each manufacturer, 60 kW, 90 KW, 150 KW, and 250 KW). The map information storage unit 121 may include, for example, fueling facility (a gasoline station) information in addition to the charging facility information. The fueling facility information includes, for example, facility type information that indicates a fueling facility, a name of the fueling facility, position information on the fueling facility (including road information facing the fueling facility), and the like.

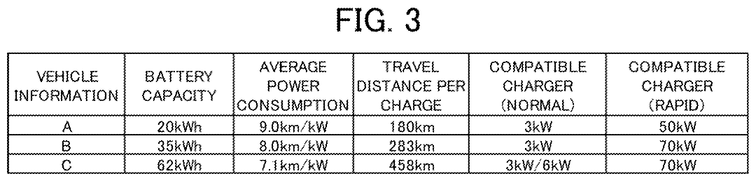

For electric vehicles sold by, for example, vehicle manufacturers, the electric vehicle information storage unit 123 stores electric vehicle performance information for each vehicle model. FIG. 3 is a diagram that illustrates an example of electric vehicle information. As illustrated in FIG. 3, the electric vehicle performance information includes, for example, for each electric vehicle that is commercially available, vehicle information (that includes the vehicle name and the like) of the electric vehicle, battery capacity (kWh), average power consumption (Wh/km), travel distance per charge, compatible normal charging (normal charging of 3 kWh or 6 kWh), and compatible rapid charging (compatible rapid charging with a maximum power output of, for example, up to 50 kW or up to 70 KW).

Electric vehicles are not compatible with any normal charging or any rapid charging, and a power output for normal charging and a power output for rapid charging that are compatible with a vehicle model of the electric vehicle are determined in advance by the vehicle model of the electric vehicle. As illustrated in FIG. 3, an output for normal charging and an output for rapid charging that are compatible with the electric vehicle are determined by selecting the vehicle model of the electric vehicle.

Although the storage unit 12 is described above, the facility information that is stored in the map information storage unit 121, for example, may be configured to be stored in advance, or may be configured to be appropriately downloaded as necessary from a server (not shown) or the like that is connected to the communication network 30. Further, these pieces of information may be appropriately modified in accordance with user input or the like.

The communication unit 13 has a digital signal processor (DSP) or the like and achieves wireless communication or wired communication with the mobile terminal 20A or another apparatus (for example, the server or the like described above) via the communication network 30 in accordance with LTE (Long Term Evolution), 4G (4th Generation) or 5G (5th Generation) standards or Wi-Fi (registered trademark). The communication network 30 is achieved with a network such as the Internet and a mobile phone network, or a network that combines these networks. Further, a Local Area Network (LAN) may be included as a part of the network.

The display unit 14 is configured, for example, with a display device such as a liquid crystal display, an organic electroluminescence display and the like. The display unit 14 displays an image in response to an instruction from the control unit 11.

The input unit 15 is configured with an input device (not shown) such as a physical switch called a numeric keypad, a touch screen that is provided on the display surface of the display unit 14, and the like.

The following describes the control unit 11 in detail. The control unit 11 is configured with a microprocessor that includes a CPU, a RAM, a ROM, and an I/O interface. The CPU executes each program that is read out from the ROM or the storage unit 12, reads information from the RAM, the ROM, and the storage unit 12 at the time of execution, writes the information to the RAM and the storage unit 12, and transmits and receives signals to and from the communication unit 13. Therefore, in such way, hardware and software (program) cooperate to achieve processes according to the present embodiment.

As illustrated in FIG. 2, the control unit 11 includes, as functional blocks, a position information acquisition unit 110, a ride information acquisition unit 111, a SoC calculation unit 112, and an output unit 113.

The position information acquisition unit 110 acquires the movement information that includes a transition-over-time of the position information from the mobile terminal 20A that is an information terminal carried by each user.

Specifically, the position information acquisition unit 110 acquires position information (latitude and longitude) of the mobile terminal 20A that is determined by the GPS sensor of the mobile terminal 20A receiving the GPS satellite signal, for example, and time information with which the position information is determined. Further, the position information acquisition unit 110 may acquire, from the mobile terminal 20A, the speed information and the vibration information that are measured by the acceleration sensor, the vibration sensor, or the like that is included in the mobile terminal 20A together with the position information. The position information acquisition unit 110 stores, in the storage unit 12, each of the acquired position information, the acquired time information, the acquired speed information, the acquired vibration information, and the like of the mobile terminal 20A in association with the terminal ID of the mobile terminal 20A (e.g., telephone number of the mobile terminal 20A).

The ride information acquisition unit 111 acquires, from the movement information acquired during a predetermined period (for example, one day), the ride information that includes at least the movement distance information and the waypoint information on the vehicle 20 that the user drives.

The following describes an example in which the vehicle substitute simulation device 1 receives, from the user of mobile terminal 20A, instructions to perform a simulation process, for “a day” that is set as the predetermined period, of a case in which the user switches from the vehicle 20 to an electric vehicle and departs from their home, travels to one or more facilities such as a restaurant, a park, and a shopping mall as a destination (waypoint), and returns to their home.

Specifically, for example, in a case in which instructions are received to perform a simulation process for a case in which the user switches from the vehicle 20 owned by the user to an electric vehicle, the ride information acquisition unit 111 reads, from the storage unit 12, position information, time information, speed information, vibration information, and the like of the “a day” that is set as the predetermined period in the instruction from among the positional information, the time information, the speed information, the vibration information and the like of the mobile terminal 20A that is stored in the storage unit 12. The ride information acquisition unit 111 uses the position information, the time information, and the like that are read for the predetermined period of “one day”, map information in the map information storage unit 121, and a well-known method in Non-Patent Document 1, etc. to determine the state (for example, whether the user is riding in a vehicle, whether the user is riding on a train, or whether the user is walking) of the user.

For example, in a case in which a transition-over-time of the position information on the mobile terminal 20A coincides with a node (for example, an intersection, a bending point, an end point, or the like) on a road of the map information in the map information storage unit 121 and coincides with positional information on a link that is a route connecting nodes, and the speed information on the mobile terminal 20A is a predetermined value (for example, 10 km per hour) or greater, the ride information acquisition unit 111 determines that the user is “riding in a vehicle”. Note that, from among the position information on the mobile terminal 20A that is initially determined as “riding in a vehicle” for the one day, the ride information acquisition unit 111 may determine an initial position information as the home of the user and acquire the initial position information as departure position information.

Further, in a case in which the transition-over-time of the position information on the mobile terminal 20A coincides with information relating to a railroad line (public transit system) of the map information in the map information storage unit 121 and in which the speed information on the mobile terminal 20A is a predetermined value (for example, 10 km per hour) or greater, the ride information acquisition unit 111 may determine that the user of the mobile terminal 20A is “riding on a train (moving by a public transit system)”. In this case, the ride information acquisition unit 111 excludes the position information on the mobile terminal 20A for the period in which the mobile terminal 20A was determined as “riding on a train” as movement by a means other than the vehicle 20.

Further, in a case in which a transition-over-time of the position information on the mobile terminal 20A coincides with a node (for example, an intersection, a bending point, an end point, or the like) on a road of the map information in the map information storage unit 121 and coincides with positional information on a link that is a road connecting between nodes, but a speed that is calculated from the transition-over-time of the mobile terminal 20A is for example, 4 km per hour or less, the ride information acquisition unit 111 may determine that the user of the mobile terminal 20A is “walking”. In this case, the ride information acquisition unit 111 excludes the position information on the mobile terminal 20A for the period in which the mobile terminal 20A was determined as “walking” as movement by a means other than the vehicle 20.

Further, in a case in which the transition-over-time of the position information on the mobile terminal 20A is at a position within a predetermined range (for example, a radius of 500 m) for a predetermined time (for example, 30 minutes or 1 hour) or greater and in which a facility such as a restaurant, a park, and a shopping mall exists in the map information in the map information storage unit 121 at the position of the mobile terminal 20A, the ride information acquisition unit 111 may determine that the user of the mobile terminal 20A is staying at the facility and acquire the facility as a waypoint in the waypoint information. A case in which the user returns to the home from the last visited facility, the ride information acquisition unit 111 preferably also acquires the home of the user as a waypoint in the waypoint information. Further, in a case in which the user leaves the home and then does not return to the home in the evening (or at night) such as a case of travelling to a vacation destination and a case of travelling to a business trip destination, the ride information acquisition unit 111 may acquire a facility at the vacation destination or the business trip destination, or the like as a waypoint in the waypoint information.

Then, the ride information acquisition unit 111 calculates a movement distance for each waypoint included in the waypoint information by the vehicle 20 from the transition of the position information only for the time in a case in which the state of the user is “riding in a vehicle”, and acquires the movement distance as the movement distance information. The ride information acquisition unit 111 outputs the acquired departure position information, the movement distance information, the waypoint information, and the like to the SoC calculation unit 112.

The State of Charge (SoC) calculation unit 112 calculates, from the electric vehicle performance information and the ride information in the electric vehicle information storage unit 123, a remaining amount of electric power (SoC) of the electric vehicle as the SoC information for each waypoint for a case in which the user switches from the vehicle 20 to the electric vehicle.

Specifically, for example, the SoC calculation unit 112 can calculate a power consumption necessary for moving the electric vehicle between the waypoints by calculating, based on the movement distance information (the movement distance between each waypoint in the waypoint information) acquired by the ride information acquisition unit 111 and on the average power consumption (Wh/km) of the electric vehicle, a product of two values as shown in Equation 1. As shown in FIG. 3, the average power consumption is set for each electric vehicle model.

$$Power consumption necessary for movement between waypoints = average power consumption \times movement distance between waypoints \qquad ( Equation 1 )$$

In a case in which the battery of the electric vehicle is in a fully-charged state (the SoC is 100%) at the time of departure from the home, the SoC calculation unit 112 calculates the SoC for each k-th waypoint in the waypoint information using Equation 2. Note that k is an integer of 1 to n, and the n-th waypoint indicates, for example, the home of the user who has returned to their home. As shown in FIG. 3, the battery capacity is set for each electric vehicle model.

$$SoC ( k - th waypoint ) = 100 \% - ( {Σ}_{b e t ween waypoints} power consumption necessary for movement between waypoints ) / ( battery capacity ) \times 100 \qquad ( Equation 2 )$$

The output unit 113 outputs, to the mobile terminal 20A via the communication network 30, the SoC information for each waypoint calculated by the SoC calculation unit 112 for a case in which the user switches from the vehicle 20 that is owned by the user to an electric vehicle and adopts the same travel mode as a travel mode of the vehicle 20.

### <Mobile Terminal 20A>

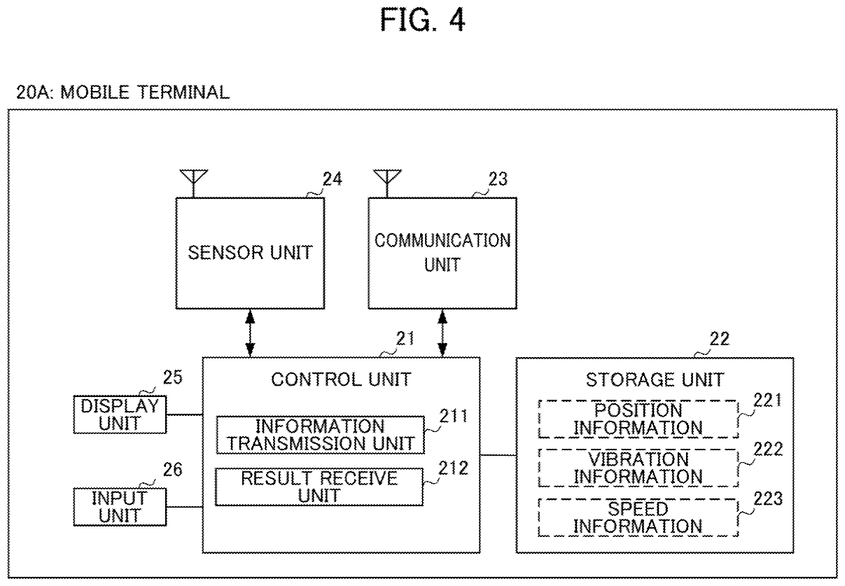

The functional blocks included in the mobile terminal 20A are described with reference to a block diagram in FIG. 4. As illustrated in FIG. 4, the mobile terminal 20A includes a control unit 21, a storage unit 22, a communication unit 23, a sensor unit 24, a display unit 25, and an input unit 26.

The control unit 21 is configured with an arithmetic processor such as a microprocessor and controls each unit that configures the mobile terminal 20A. The control unit 21 is described in detail later.

The storage unit 22 is configured with a semiconductor memory or the like, and stores various kinds of information, such as a program that execute functions for transmitting position information and time information to the vehicle substitute simulation device and a program such as control programs called firmware and operating systems and programs. FIG. 4 illustrates position information 221, vibration information 222, and speed information 223 as information that is stored by the storage unit 22. The storage unit 22 may store other information.

The position information 221 includes position information (latitude and longitude) of the mobile terminal 20A by the GPS sensor that is included in a sensor unit 24 described later receiving the GPS satellite signal, and time information with which the position information is determined.

The vibration information 222 includes vibration information on the mobile terminal 20A measured by the acceleration sensor, the vibration sensor, or the like that is included in the sensor unit 24 described later.

The speed information 223 includes speed information on a moving speed of the mobile terminal 20A measured by the acceleration sensor, the vibration sensor, or the like that is included in the sensor unit 24 described later.

The communication unit 23 has a digital signal processor (DSP) or the like and achieves wireless communication or wired communication with the mobile terminal 20A or another apparatus (for example, the vehicle substitute simulation device 1) via the communication network 30 in accordance with LTE (Long Term Evolution), 4G (4th Generation) or 5G (5th Generation) standards or Wi-Fi (registered trademark). The communication unit 23 is used, for example, for transmitting, from the mobile terminal 20A to the vehicle substitute simulation device 1, the identification information (terminal ID), position information 221, vibration information 222, speed information 223, and the like of the mobile terminal 20A.

In addition, each time new position information, new time information, new vibration information, new speed information, or the like is acquired, the communication unit 23 may transmit, to the vehicle substitute simulation device 1, the new position information, the new time information, the new vibration information, the new speed information, or the like. Alternatively, the communication unit 23 may collectively transmit, to the vehicle substitute simulation device 1 and for every period of a predetermined time (for example, one minute or the like), position information, time information, vibration information, speed information and the like that have been acquired.

The data transmitted and received between the communication unit 23 and the other apparatus is not particularly limited, and other information may be transmitted and received.

The sensor unit 24 is configured with, for example, the GPS sensor, the acceleration sensor, and the vibration sensor. The sensor unit 24 uses the acceleration sensor, the vibration sensor, or the like to measure the moving speed and vibrations of the mobile terminal 20A. In addition, the sensor unit 24 receives the GPS satellite signal by the GPS sensor, measures position information (latitude and longitude) of the mobile terminal 20A, and acquires time information in a case in which the position information is determined.

The display unit 25 is configured with a display device such as a liquid crystal display and an organic electroluminescence display. The display unit 25 displays an image in response to an instruction from the control unit 21. Examples of information displayed by the display unit 25 include a user interface that corresponds to various application programs installed in the mobile terminal 20A.

The input unit 26 is configured with an input device such as a physical switch called a numeric keypad, a touch screen that is provided on the display surface of the display unit 25, and the like. The input unit enables operations selected by the user to be carried by outputting, to the control unit 21, a signal based on an operation input, for example, a user pressing keys on a numeric keypad or touching a touch screen, from the input unit 26.

Although not shown, the mobile terminal 20A can also include a speaker, a microphone, and the like. In this way, information can be output from a speaker by voice, or various selections and instructions from a user that are verbally input via the microphone can be input to the control unit 21 by voice recognition technology.

The following describes the control unit 21 in detail. The control unit 21 is configured with a microprocessor that includes a CPU, a RAM, a ROM, and an I/O interface. The CPU executes each program that is read from the ROM or the storage unit 22, reads information from the RAM, the ROM, and the storage unit 22 at the time of execution, writes the information to the RAM and the storage unit 22, and transmits and receives signals to and from the communicationpl unit 23 the sensor unit 24, the display unit 25, and the input unit 26. Accordingly, hardware and software (program) cooperate to achieve processes according to the present embodiment.

An information transmission unit 211 transmits the position information 221, the vibration information 222, the speed information 223, and the like of the mobile terminal 20A to the vehicle substitute simulation device 1 by wireless communication using the communication unit 23.

In a case of receiving, from the user via the input unit 26, an instruction for a simulation process for the vehicle substitute simulation device 1, the information transmission unit 211 transmits, to the vehicle substitute simulation device 1 together with the instruction for the simulation process, the terminal ID (identification information) of the mobile terminal 20A, the predetermined period (for example, one day), and a designated electric vehicle model that are necessary for the simulation process.

A result receive unit 212 receives, via the communication unit 23, a result of the simulation process executed by the vehicle substitute simulation device 1 and displays the received result of the simulation process on the display unit 25.

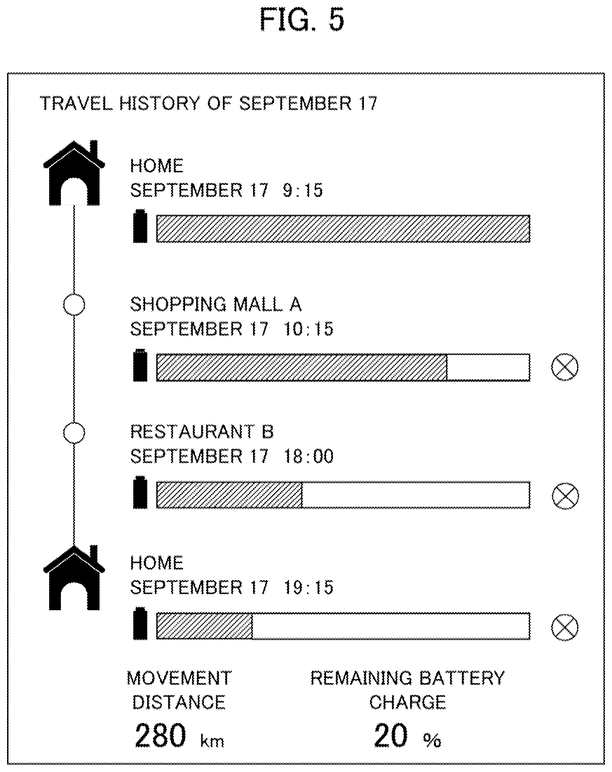

FIG. 5 is a diagram that illustrates an example of a display of the result of the simulation process.

As illustrated in FIG. 5, the result receive unit 212 can display, as a list on the display unit 25, result of the simulation process from a travel history in which the user drove the vehicle 20 on September 17. The results of the simulation process depict SoC information at each waypoint of a shopping mall A, a restaurant B, and the home for a case in which the user switches to the electric vehicle and the SoC at the time of departure is 100%.

In this way, for a case in which the user switches from the vehicle 20 to the internal combustion engine with the electric vehicle, the user can easily grasp what kind of power consumption is necessary for each waypoint, which alleviates the concerns of the user.

The above describes a configuration of the mobile terminal 20A.

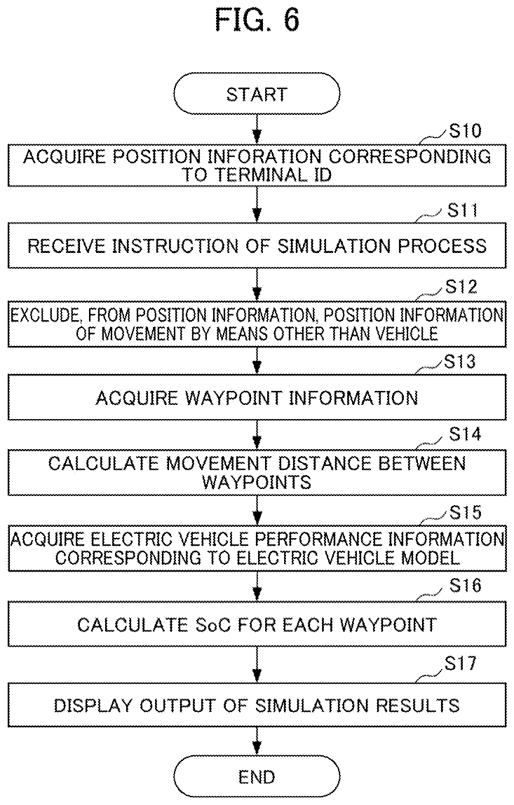

The following describes an operation of the present embodiment with reference to a flowchart illustrated in FIG. 6. FIG. 6 is a flowchart illustrating a vehicle substitute simulation process executed by the vehicle substitute simulation device 1. More specifically, FIG. 6 describes an example of a process flow in which the vehicle substitute simulation device 1 simulates the SoC information for each waypoint for a case in which the user switches from an internal combustion engine vehicle that is owned by the user to an electric vehicle and adopts a travel mode that is the same as a travel mode of the vehicle 20.

In a case in which the above simulation is executed for a plurality of electric vehicles with each electric vehicle being a different model, each vehicle model is selected one by one, the simulation process is executed for the one vehicle model that is selected according to the flowchart illustrated in FIG. 6, and in a case in which the simulation process that is executed on the one vehicle model has finished, a similar process is executed on the remaining vehicle models one by one, and this process is executed for all the specified vehicle models, thus enabling the simulation process to be executed for a plurality of electric vehicles with each electric vehicle being a different model.

In step S10, the vehicle substitute simulation device 1 (position information acquisition unit 110) acquires the position information, the time information, the vibration information, the speed information, and the like of the mobile terminal 20A of the user, and stores, in the storage unit 12, the acquired position information, the acquired time information, the acquired vibration information, the speed information, and the like in association with the terminal ID of the mobile terminal 20A.

In step S11, the vehicle substitute simulation device 1 (ride information acquisition unit 111) receives an instruction to perform a simulation process and, for the received instruction, reads, from the storage unit 12, the position information and the like of the mobile terminal 20A for the predetermined period set in the simulation process.

In step S12, the vehicle substitute simulation device 1 (ride information acquisition unit 111) excludes position information on movement by a means other than the vehicle 20 from among the position information on the mobile terminal 20A for the predetermined period or time that is read in step S11.

In step S13, in a case in which the transition of the position information only for the time in a case in which the state of the user is “riding in a vehicle” is at a position within a predetermined range (for example, a radius of 500 m) for a predetermined time (for example, 30 minutes or 1 hour) or greater, the vehicle substitute simulation device 1 (ride information acquisition unit 111) determines that the user of the mobile terminal 20A is staying at a facility such as a restaurant, a park, a shopping mall, or the like, and acquires the facility as a waypoint in the waypoint information.

In step S14, the vehicle substitute simulation device 1 (ride information acquisition unit 111) calculates a movement distance for each waypoint from the transition of the position information only for the time in a case in which the state of the user is “riding in a vehicle”, and acquires the movement distance as the movement distance information.

In step S15, the vehicle substitute simulation device 1 (SoC calculation unit 112) acquires, from the electric vehicle information storage unit 123, electric vehicle performance information (battery capacity, average power consumption, charge time (normal charging) and charge time (rapid charging)) that correspond to the electric vehicle model to be simulated.

In step S16, the vehicle substitute simulation device 1 (SoC calculation unit 112) calculates, for a case in which the user switches from the vehicle 20 to the electric vehicle, the remaining power of the electric vehicle at each waypoint as SoC information.

In step S17, the vehicle substitute simulation device 1 (output unit 113) outputs, to the mobile terminal 20A via the communication network 30, the SoC information for each waypoint calculated in step S17 and ends the simulation process.

As described above, for a case in which the user switches from a vehicle 20 that has an internal combustion engine and is owned by the user to an electric vehicle corresponding to a desired vehicle model and adopts a travel mode that is the same as a travel mode of the vehicle 20, the SoC information for each waypoint can be easily grasped from the transition of the position information on the mobile terminal 20A (the vehicle 20) within a predetermined period. In this way, objective information can be provided to the user in a case in which the user considers purchasing an electric vehicle to substitute the vehicle 20 that has an internal combustion engine.

Each device can respectively be achieved by hardware, software, or a combination thereof. Further, a navigation method executed by cooperation of each device that is included in the navigation system described above can also be achieved by hardware, software, or a combination thereof. Here, “achieved by software” means achieved by a computer reading and executing a program.

The program may be stored using various types of non-transitory computer-readable media and provided to a computer. Non-transitory computer-readable media includes various types of tangible storage media. Examples of non-transitory computer-readable media include magnetic recording media (For example, flexible disks, magnetic tapes, hard disk drives, etc.), magneto-optical recording media (e.g., magneto-optical disks), CD-ROMs (Read Only Memory), CD-Rs, CD-R/Ws, semiconductor memories (For example, a mask ROM, a PROM (Programmable ROM), an EPROM (Erasable PROM), a flash ROM, and a RAM (random access memory)). The program may also be provided to a computer by various types of transitory computer readable media. Examples of transitory computer-readable media include electrical signals, optical signals, and electromagnetic waves. The transitory computer-readable medium can provide the program to the computer via wired or wireless communication paths such as electric wires and optical fibers.

Although the above-described embodiments are preferred embodiments of the present disclosure, the scope of the present disclosure is not limited to the above-described embodiments, and various modifications can be made without departing from the gist of the present disclosure.

### Modified Example 1

In the above embodiment, the vehicle substitute simulation device 1 is described as being achieved by a single server apparatus or the like but may also be achieved by a distributed process system in which each function of the vehicle substitute simulation device 1 is distributed to a plurality of server apparatuses as appropriate. Further, each function of the vehicle substitute simulation device 1 may be achieved using a virtual server function or the like in the cloud.

### Modified Example 2

In the above embodiment, the value of SoC for each waypoint calculated by the vehicle substitute simulation device 1 is a positive value. However, the present invention is not limited to above. For example, the vehicle substitute simulation device 1 may end the simulation process upon the value of SoC becoming “0%” (out of power) and output the result of the simulation to the mobile terminal 20A. In this way, in a case of making a replacement purchase for an electric vehicle, it is possible for a user to understand, based on the result displayed on the mobile terminal 20A, which waypoint can be reached without charging, at which waypoint charging is necessary, and the like.

Alternatively, the vehicle substitute simulation device 1 may execute a simulation process that calculates the SoC at all of the waypoints, even in a case in which the value of the SoC becomes a negative value, and output the result of the simulation to the mobile terminal 20A. In this way, in a case of making a replacement purchase for an electric vehicle based on a result displayed on the mobile terminal 20A, it is possible for a user to understand how much power consumption is necessary, how many times the battery needs to be charged, at which waypoint charging is necessary, and the like until the user returns to the home.

### EXPLANATION OF REFERENCE NUMERALS

100 vehicle substitute simulation system
1 vehicle substitute simulation device
11 control unit
110 position information acquisition unit
111 ride information acquisition unit
112 SoC calculation unit
113 output unit
12 storage unit
121 map information storage unit
123 electric vehicle information storage unit
13 communication unit
14 display unit
15 input unit
20 vehicle
20A mobile terminal
21 control unit
211 information transmission unit
212 result receive unit
22 storage unit
221 position information
222 vibration information
223 speed information
23 communication unit
24 sensor unit
25 display unit
26 input unit
30 communication network

What is claimed is:

1. A vehicle substitute simulation device, comprising:
a position information acquisition unit configured to acquire movement information that includes a transition-over-time of position information from an information terminal carried by a user;
an electric vehicle information storage unit configured to store electric vehicle performance information relating to a travel performance of an electric vehicle that includes a motor driven by electricity;
a ride information acquisition unit configured to acquire, from the movement information acquired in a predetermined period, ride information that includes at least movement distance information and waypoint information on an internal combustion engine vehicle driven by the user and including an internal combustion engine;
a State of Charge (SoC) calculation unit configured to calculate, from the electric vehicle performance information and the ride information, a remaining amount of electric power (SoC) of the electric vehicle as SoC information for each waypoint for a case in which the user switches to the electric vehicle; and
an output unit configured to output, to the information terminal of the user, the SoC information for each waypoint in the waypoint information.

2. The vehicle substitute simulation device according to claim 1, wherein in a case in which the transition of the position information is at a position within a predetermined range for a predetermined time or longer, the ride information acquisition unit determines that the position is one waypoint.

3. The vehicle substitute simulation device according to claim 1, wherein
the position information acquisition unit further acquires vibration information on the information terminal, and
the ride information acquisition unit determines, based on the vibration information, whether or not the internal combustion engine vehicle moves and then acquires the movement distance information.

4. The vehicle substitute simulation device according to claim 1, further comprising a map information storage unit configured to store map information that includes information on a public transit system, wherein
the ride information acquisition unit determines, based on the map information, whether the transition of the position information is movement by the internal combustion engine vehicle or movement by the public transit system and then acquires the movement distance information.

5. The vehicle substitute simulation device according to claim 1, wherein
the electric vehicle information storage unit further stores the electric vehicle performance information for each vehicle model of a plurality of electric vehicles, and
the SoC calculation unit calculates the SoC information for each waypoint for each vehicle model of the plurality of electric vehicles.

6. A vehicle substitute simulation method executed by a computer, comprising:
a position information acquisition step of acquiring movement information that includes a transition-over-time of position information from an information terminal carried by a user;
an electric vehicle information storage step of storing electric vehicle performance information relating to a travel performance of an electric vehicle that includes a motor driven by electricity;
a ride information acquisition step of acquiring, from the movement information acquired in a predetermined period, ride information that includes at least movement distance information and waypoint information on an internal combustion engine vehicle driven by the user and including an internal combustion engine;
an SoC calculation step of calculating, from the electric vehicle performance information and the ride information, a remaining amount of electric power (SoC) of the electric vehicle as SoC information for each waypoint for a case in which the user switches from the internal combustion engine vehicle to the electric vehicle; and
an output step of outputting, to the information terminal of the user, the SoC information for each waypoint in the waypoint information.
